(19) United States
(12) Patent Application Publication
(10) Pub. No.: US 2025/0335553 A1
(43) Pub. Date: Oct. 30, 2025

(54) Method and Related Components for Object Persistence and Monetization in Generative AI Platforms

(71) Applicant: James Jeffrey Allen, Portland, OR (US)

(72) Inventor: James Jeffrey Allen, Portland, OR (US)

(21) Appl. No.: 19/183,808

(22) Filed: Apr. 19, 2025

Related U.S. Application Data
(60) Provisional application No. 63/638,914, filed on Apr. 25, 2024.
(60) Provisional application No. 63/676,393, filed on Jul. 28, 2024.

(51) Int. Cl. G06F 21/10; G06F 21/60

(52) U.S. Cl. CPC G06F 21/107; G06F 21/602

(57) ABSTRACT

A method, process, and/or technique for creating and/or using one or more unique identifiers for at least one digital object. The method may include providing prompts; receiving inputs in response to the prompts; applying machine learning to the inputs to create the one or more unique identifiers; and associating the one or more unique identifiers with the at least one digital object. Also, a device that uses machine learning to effectuate the subject technology.

### CROSS REFERENCE TO RELATED APPLICATIONS

This application claims the benefit of and priority from U.S. provisional application No. 63/638,914 filed 25 Apr. 2024 and U.S. provisional application No. 63/676,393 filed 28 Jul. 2024 having a title “A Method for Object Persistence and Monetization in Generative AI Platforms” and the same inventor as this application.

### BACKGROUND

AI-powered generated image and video (“Generative AI”) is new technology. Generative AI takes the input of a “prompt” and uses machine learning algorithms-based on extensive AI training—to create (or generate) images and video with and without audio, which we shall call “generated likenesses” in the plural, “generated likeness” in the singular in this document.

The subject technology attempts to address issues related to Generative AI.

### BRIEF SUMMARY OF THE INVENTION

Aspects of the subject technology include but are not limited to one or more methods, processes, and/or techniques that create and/or use unique identifiers in generative AI prompts and/or central storage repositories to enable copyright owners of generated likenesses to license and/or receive payment for their works in generative AI text, image, video and audio platforms. An example method includes providing prompts; receiving inputs in response to the prompts; applying machine learning to the inputs to create the one or more unique identifiers; and associating the one or more unique identifiers with the at least one digital object. The subject technology also encompasses one or more devices that use machine learning to effectuate the subject technology.

### BRIEF DESCRIPTION OF THE SEVERAL VIEWS OF THE DRAWINGS

FIG. 1 illustrates a unique ID creation process according to aspects of the subject technology.

FIG. 2 illustrates a pre-processing process according to aspects of the subject technology.

FIG. 3 illustrates a restriction detection process according to aspects of the subject technology.

FIG. 4 illustrates a usage detection process according to aspects of the subject technology.

FIG. 5 illustrates a contract settlement process according to aspects of the subject technology.

FIG. 6 illustrates an example of a marketplace enabled using Generative AI according to aspects of the subject technology.

FIG. 7 illustrates an example problem with some existing processes related to licensing of work(s).

FIG. 8 illustrates end-to-end Generative AI transparency according to aspects of the subject technology.

FIG. 9 illustrates regenerated data and/or metadata involving royalties according to aspects of the subject technology.

FIG. 10 illustrates one possible implementation of leveraging aspects of the subject technology for monetization.

FIG. 11 illustrates further possible details of leveraging aspects of the subject technology.

FIG. 12 illustrates a Software as a Service (Saas) model that may be used to leverage aspects of the subject technology.

FIG. 13 illustrates Application Program Interfaces (APIs) and applications that may be used to implement aspects of the subject technology.

FIG. 14 illustrates a possible solution roadmap according to aspects of the subject technology.

FIG. 15 illustrates possible product components according to aspects of the subject technology.

FIG. 16 illustrates a possible consumer use “flywheel” according to aspects of the subject technology.

FIG. 17 illustrates product components for possible expansion(s) according to aspects of the subject technology.

### DETAILED DESCRIPTION

U.S. provisional application Nos. 63/638,914 and 63/676,393 including all figures and associated documents (e.g., appendices) are hereby incorporated by reference as if fully set forth herein. These provisional applications should not be considered limiting.

There are many different methods being used to generate the generative likeness output. At the core, Generative AI platforms are “trained” to re-create new generated likenesses based on previously know or similar likenesses. Objects with generated likeness in Generative AI platforms can be anything—storylines, object representations based on real world attributes, object representations based on fictional or created attributes, movements, facial features, voiceprints, scenes, trademarks, signage, brands, etc. However, much fear has been stoked that copyrighted materials, personal image and other likenesses have been used to train the AI models, and that original creators have not explicitly licensed their unique or copyrighted likenesses for use in this manner. In some cases, generated likenesses look exactly like or similarly to prior art. Some owners of copyrighted material or likenesses may find it desirable to license their works for profit. Other owners of copyrighted material or likenesses—such as brands—may find it desirable to pay others to use their likenesses to garner promotion.

In most Generative AI platforms, the “prompt” serves as an input to AI platforms. The prompt—in most cases—consists of text that describes the attributes of the desired output. One example might be “Generate a video consisting of 3 shots each 4 seconds long from different camera angles of a stormtrooper walking down a Parisian street in broad daylight, with crowds of people watching from each side.”

The AI platform would interpret that description to produce a video with the desired attributes. rom this prompt, a “stormtrooper” for example could be interpreted as a German stormtrooper from the 1930s, the training of which would come from public domain video—or it could be interpreted as a stormtrooper from the movie Star Wars—or some other interpretation. The generative video platform may make a different determination of the prompter's intent each time the same prompt is displayed.

Interestingly, in nearly all cases, the same prompt is likely to produce widely varying results. In this example, different streets, background buildings, camera angles, crowd representations, trees, and stormtroopers may appear differently in different generated versions.

Inconsistency of the generated likenesses is a key problem for copyright owners, for brands that would like to incentivize creators to use generated likenesses in creators' final products, and for creators that would like to license others' generated likenesses in their creation. Inconsistency further exacerbates costs: when generated video produces different results even when the same prompt is used and a specific licensed object is required in the output—the creation must be re-generated, often multiple times to get the desired result, with compute costs applied each time.

Additionally, when a creator of generative likenesses is creating multiple video clips that are eventually stitched together to form longer form content such as a TV show or movie—but wants to feature the same unique likeness, character likeness, etc. throughout each scene (whether copyrighted or not)—today's technology does not allow for such persistence or consistency.

To maintain object persistence while granting a license from copyright owner to a creator licensee for us in generative likenesses—a new method is proposed.

This system describes methods, processes, and techniques by which a unique identifier may be created for each copyrighted or licenseable original art (the “unique object”). The unique identifier preferably is stored, along with its generative likeness and license attributes, in a central repository that preferably can verify uniqueness relative to other identifiers at the time of creation. The interface for this creation preferably can be through a user interface such as a web page or software program, through APIs or other similar methods. The central repository could be a blockchain, database or cloud-based file system that can be accessed through a user interface or an API. The unique identifier can be numeric, text, alphanumeric or any other data method where unique combinations can be reserved and resolved in a central repository. Examples: 3483u267764, #StarWarsStormTropper, #connectedjeff@gmail.com-GenAIPersonalLikeness, etc.

Also through a user interface, APIs or other methods, attributes of the unique object such as text, image and video files relating to the unique objects' storylines, object representations based on real world attributes, object representations based on fictional or created attributes, movements, facial features, voiceprints, scenes, trademarks, signage, brands, etc.—would be attached the unique identifier in the central repository.

Also through a user interface, APIs or other methods, the copyright owner can add one-time royalty, per-use royalty, exclusive, non-exclusive, a pay-to-creator, and/or other contract parameters and payment method—and attach this information to the unique identifier in the central repository. This information formulates a proposed royalty contract.

Once a prompt is created, a pre-prompt processor would analyze the prompt to identify unique identifiers that may exist within the prompt. One example implementation would be to use a symbol like “#” at the beginning of unique identifiers so that a pre-prompt processor could more easily identify potential unique identifiers and discard non-potential unique identifiers.

The unique identifier found by the pre-processor can then be used to retrieve attributes (the likeness and the proposed royalty contract information) when the unique identifier is inserted into the prompts for the AI platform. The pre-prompt process can then trigger a process to present to the creator (in a computer interface) the royalty required—or the payment offered to place—the unique object's likeness in their final product. If accepted, the creator's acceptance of the royalty preferably is recorded as a unique contract associated with the unique identifier in the central repository. The likeness can then be provided to the AI platform for training and/or generation purposes.

Note that in some implementations, an AI platform may already have trained on generating likenesses for the unique object—but such AI platform may have (or should have) created an internal method for segmenting what it has been trained on and will not generate a likeness for the unique object unless it has validated that the creator using the unique identifier in the prompt has a valid contract. This validation preferably occurs by using the unique identifier to look up the creator's unique contract information in the central repository to determine if the AI platform is authorized to use its training to generate new likenesses based on the unique object.

For usage-based or view-based royalties, a watermark can additionally be added to generated likenesses, images and videos for verification purposes. Systems that detect watermarks on images and videos can track such usage, and report usage—also placing such information on the contracts in the central repository. This information can then be used by billing and payment platforms to settle contracts.

### Possible Embodiments

Some possible embodiments of the subject technology may include a method that creates one or more unique identifiers for at least one digital object. Steps of the method may include providing prompts, receiving inputs in response to the prompts, applying machine learning to the inputs to create the one or more unique identifiers, and associating the one or more unique identifiers with the at least one digital object. The at least one digital object comprises one or more of images, videos, audio, 3D models, skins, textures, voiceforms, metadata, and/or other information relating to the object.

In some aspects, generating the prompts may involve one or more blockchains. The blockchains may be stored in one or more ledgers, which may be centralized or decentralized. The blockchain and/or blockchains preferably include information related to usage of the at least one digital object.

Retrieval of the at least one digital object may be enabled at least in part based on the one or more unique identifiers associated with the at least one digital object.

Other methods may implement the subject technology. These methods may include some or all the elements described above and otherwise herein.

Machine learning and/or other forms of artificial intelligence preferably are used to enable and/or implement the subject technology.

### Example Use

In our method, by way of example, a hypothetical copyright owner of the likeness for the Star Wars Stormtrooper, would generate and validate a unique identifier—for example #StarWarsStormTrooper—in the blockchain. The copyright owner would then upload—and our system would attach the likeness information—text, images, and video that describe the Star Wars Stormtrooper (and used by AI platforms to generate subsequent likenesses). The copyright owner would then create through a computer interface a per-view royalty that creators may pay to use the likeness information to create generated likenesses in their creation. Collectively all this information preferably is stored on the blockchain and associated with the unique identifier.

In our method, we would modify the prompt example provided above to read (for example): “Generate a video consisting of 3 shots each 4 seconds long from different camera angles of a #StarWarsStormTrooper walking down a Parisian street in broad daylight, with crowds of people watching from each side.

By including the unique identifier in the prompt or API for the AI platform (vs. a generic term like “stormtrooper” which may have many different non-copyrighted likenesses and meanings), the prompt pre-processor would identify the unique identifier, retrieve the proposed contract information, and present it to the creator. If the creator accepts the proposed contract, then a unique contract preferably is created on the blockchain between the copyright owner and the creator—and authorize the prompt pre-processor to further retrieve the text, image and video likeness. The prompt pre-processor can pass the information to an AI platform to train the AI platform on this object (or enable a pre-trained AI platform to use these trainings) and create images or videos with embedded generated likenesses for the creator who has a valid unique contract.

### Figures

Numerous figures are included with this filing. The figures are believed to be self-explanatory and to cover novel and non-obvious aspects of the subject technology. Further details of the drawing figures follow:

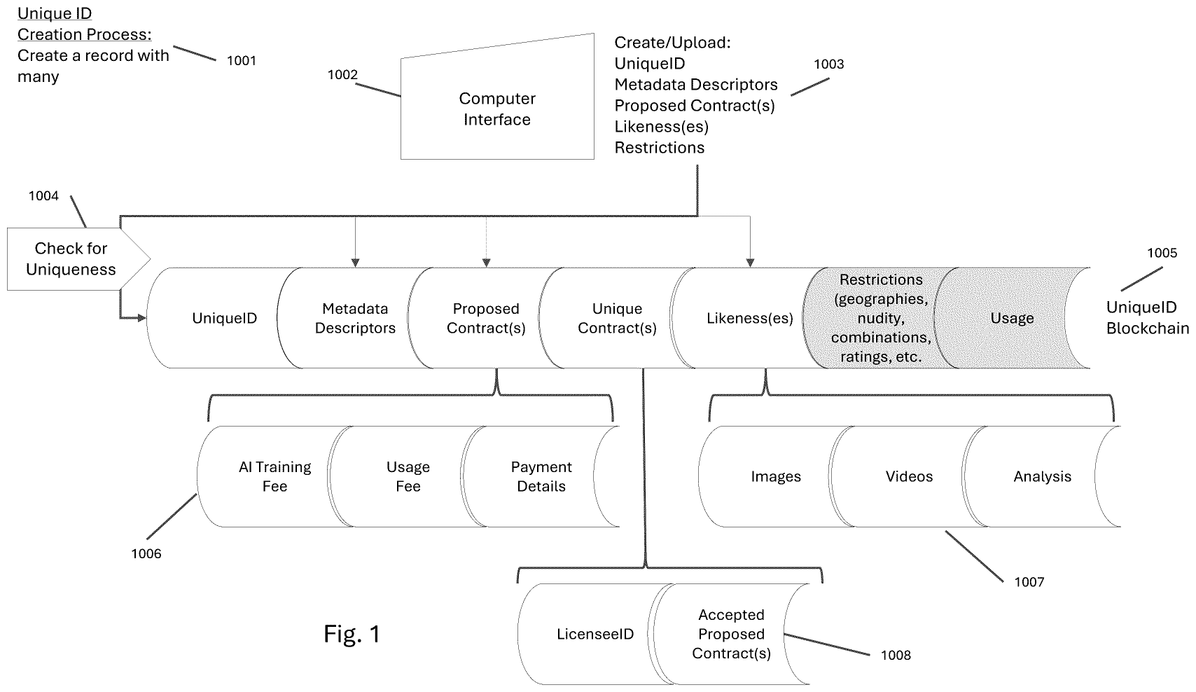

FIG. 1 illustrates a unique ID creation process according to aspects of the subject technology. Element 1001 indicates a unique identification (unique ID) process. Computer interface 1002 is intended to enable creating and/or upload 1003 of metadata descriptors, proposed contract(s), likeness(es), and/or restriction(s) for example regarding geographics, nudity, combinations of such and/or other items, etc.

Element 1004 represents checking for uniqueness for example a unique identifier (unique ID) 1005 for a blockchain related to the creation/upload process. Elements of unique identifier 1005 may include but are not limited to some or all of a unique ID, a metadata descriptor, a proposed contract, unique contract(s), likenesses (for example name/image/likeness aka NIL for sports), possible restrictions for example regarding geography, nudity, combinations/fake images, ratings, etc. Elements regarding usage may also be included in unique ID blockchain 1005.

Elements 1006 represent that proposed contract(s) may involve AI training fee(s), usage fee(s), payment details, and/or other contractual terms.

The likenesses may include images, videos, analysis of such, usage of such, and/or other data as represented by element 1007.

Element 1008 represents possible inclusion of a licensee identification and/or accepted proposed and/or offered contract(s) related to some and/or all the other elements shown in FIG. 1. Other factors, considerations, terms, and agreements may be involved.

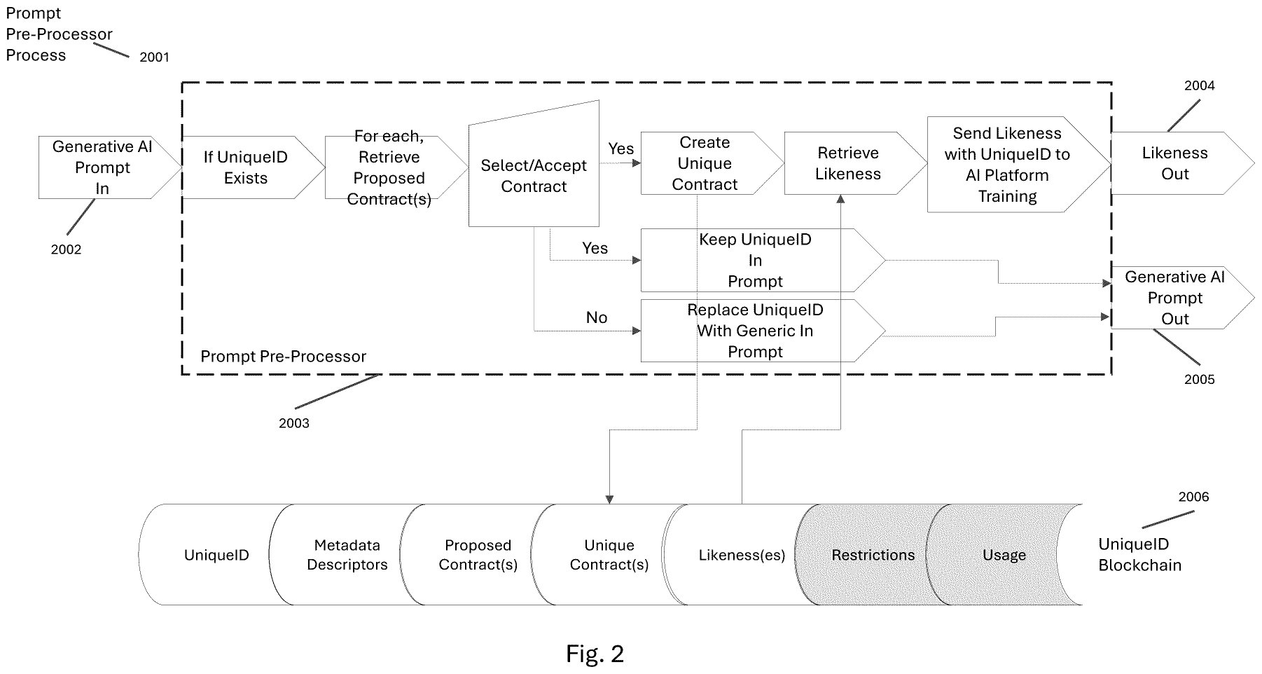

FIG. 2 illustrates pre-processing process 2001 according to aspects of the subject technology. Generative AI process in (input) 2002 represents pre-processing of various possible information provided by for example users, databases, AIs, and/or other sources. This information may include if a unique ID exists, proposed contract(s), and selection/acceptation of contract(s) and/or other information.

Prompt pre-processing/processor 2003 includes multiple possible paths for handling generative AI process(es) in (input) 2002. Multiple paths preferably are available.

Example paths for accepted contract(s) include a first path involving creating a unique contract possibly as an input to unique contract(s) for unique ID blockchain 2006, an input from likeness(es) that may be retrieved from unique ID blockchain 2006, and sending likeness(es) with unique ID(s) to a platform such as an AI platform for training. Some, all, and/or other information for contract(s) may be involved.

Element 2004 represents likeness(es), contract(s), and/or other information being output. Another example for accepted contract(s) includes a second path involving keeping unique ID(s) from generative AI prompt 2002. This path may lead to a generative AI prompt out 2005, which may be re-input into generative AI process in (input) 2002.

An example path for unaccepted contract(s) includes replacing a unique ID with a generic version of the prompt. This path may also lead to generative AI(s) outputting prompt out 2005, which may be re-input into generative AI process in (input) 2002.

Unique ID blockchain(s) 2006 may include various elements including unique ID(s), metadata descriptor(s), proposed contract(s), unique contract(s), likeness(es), restriction(s), and usage(s). Some, all, and/or other information may be included in or associated with unique ID blockchain(s) 2006.

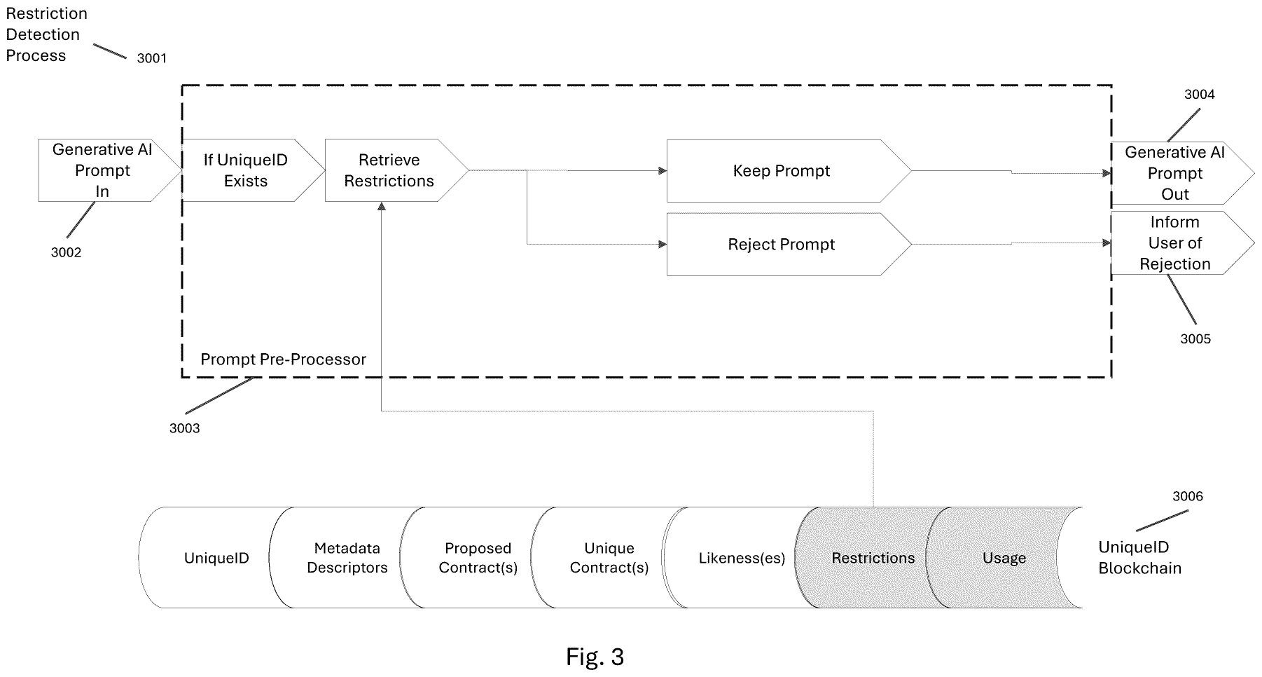

FIG. 3 illustrates restriction detection process 3001 according to aspects of the subject technology. Generative AI process in (input) 3002 represents pre-processing of various possible information provided by for example users, databases, AIs, and/or other sources. This information may include if a unique ID exists, proposed contract(s), and selection/acceptation of contract(s) and/or other information.

Prompt pre-processing/processor 3003 includes multiple possible paths for handling generative AI process(es) in (input) 3002. Multiple paths preferably are available. Elements of Prompt pre-processing/processor 3003 may include determining if a unique ID exists, receiving restriction(s) from unique ID blockchain(s) 3006 as described above with respect to unique ID blockchain(s) 2006, keeping prompt(s) and/or information, and/or rejection prompt(s), and/or information.

Element 3004 represents generation of AI prompt(s) out as described above with respect to element 2005 in FIG. 2. User(s) may be informed that their prompt and/or other information is rejected by element 3005.

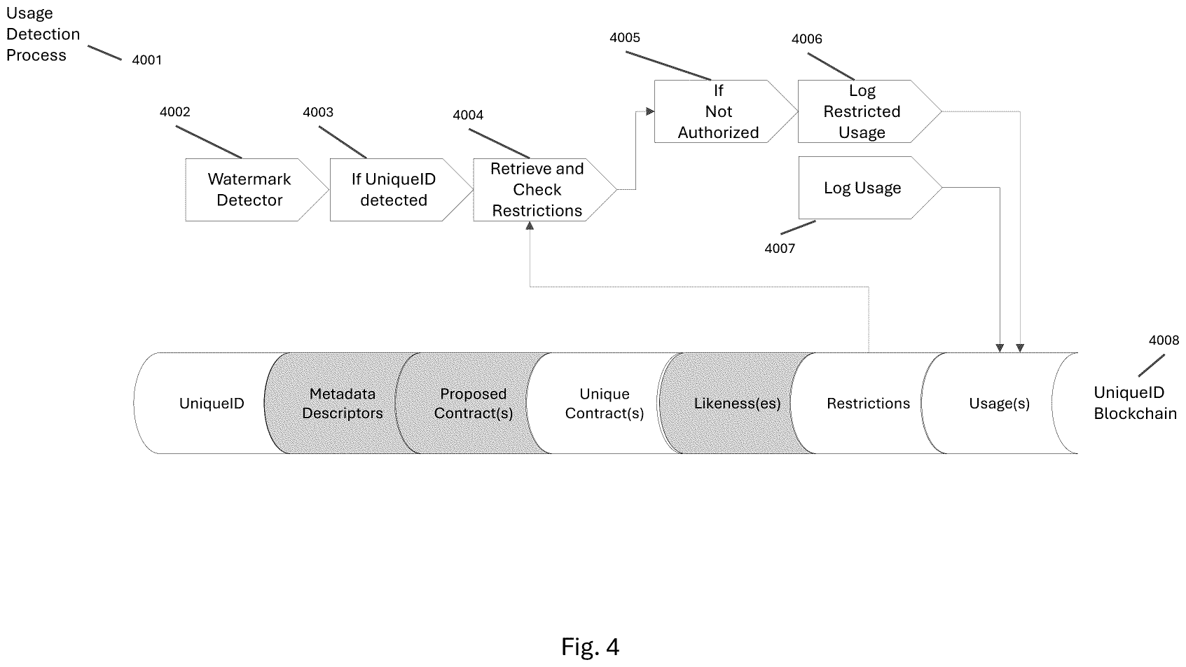

FIG. 4 illustrates usage detection process 4001 according to aspects of the subject technology. Element 4002 represents watermark detector/detection for provided information. Unique ID(s) may be detected 4003 based on input to process 4001. Preferably relevant restriction(s) may be retrieved and/or checked 4004 from unique ID blockchain 4008. If usage of use of the provided information is not authorized in element 4005, log of the restricted usage 4006 may be generated. If usage is authorized, log(s) of the usage 4007 may also be generated. This information may be included in unique blockchain 4008 for example as usage(s).

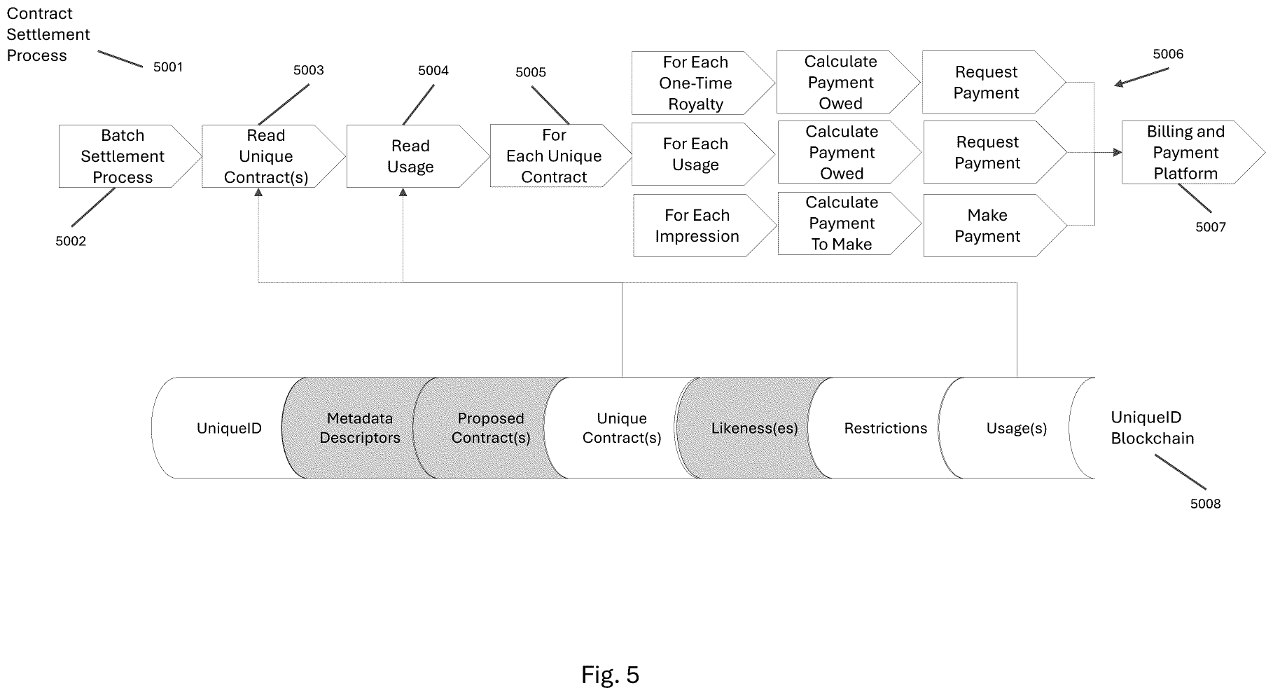

FIG. 5 illustrates contract settlement process 5001 according to aspects of the subject technology. Batch settlement may be initiated in element 5002. Usage contract(s) may be read 5002 preferably from unique ID blockchain 5008. Likewise, usage preferably may be read 5002 preferably form unique ID blockchain 5008. For each unique contract and/or contracts and usage, various paths preferably exist. Examples 5006 include but are not limited to the following: for each one-time royalty, payment(s) may be calculated, and payment request(s) may be made; for each usage (e.g., multiple usage context), payment(s) may be calculated and payment request(s) may be made; and for each impression payment(s) may be calculated and payment(s) made.

All of the described paths, some of the paths, and/or other paths for the processes/elements illustrated in and described with respect to FIGS. 1, 2, 3, 4, and 5 may overlap. Some of the elements shown in these figures may be omitted and other elements may be included.

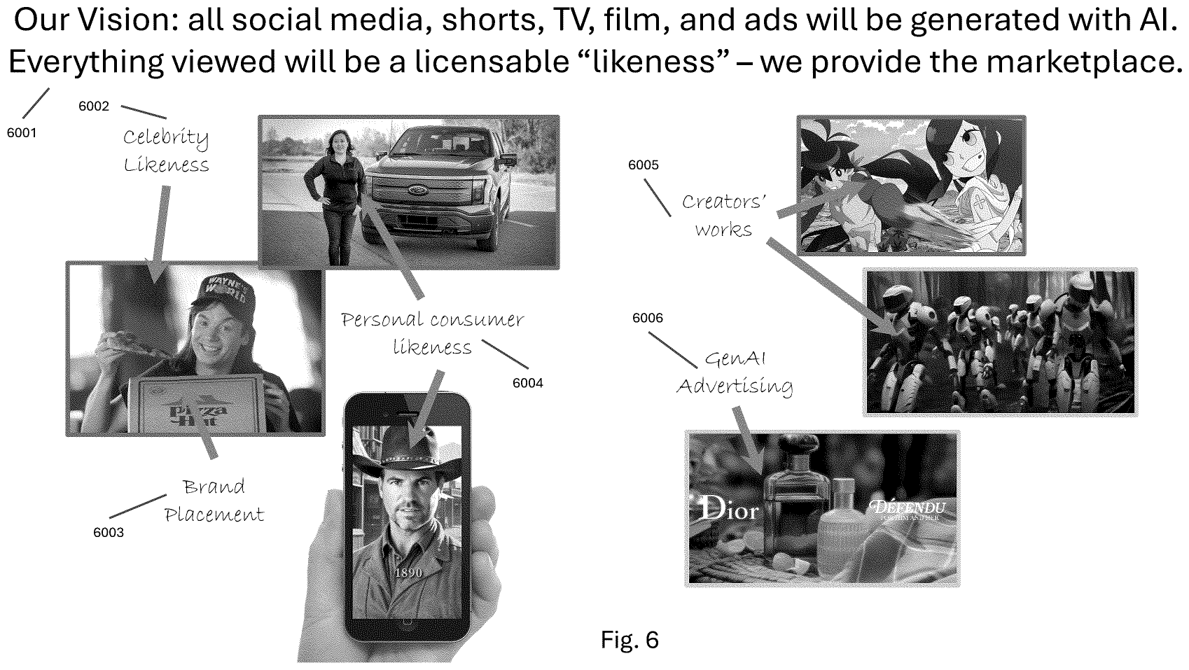

FIG. 6 illustrates example 6001 of a marketplace enabled using Generative AI according to aspects of the subject technology. Celebrity likeness 6002, brand placement 6003, and personal consumer likeness 6004 may be involved. Creator(s)' work(s) 6005 (e.g., images, videos, print, etc.) may be used for generative AI advertising 6006.

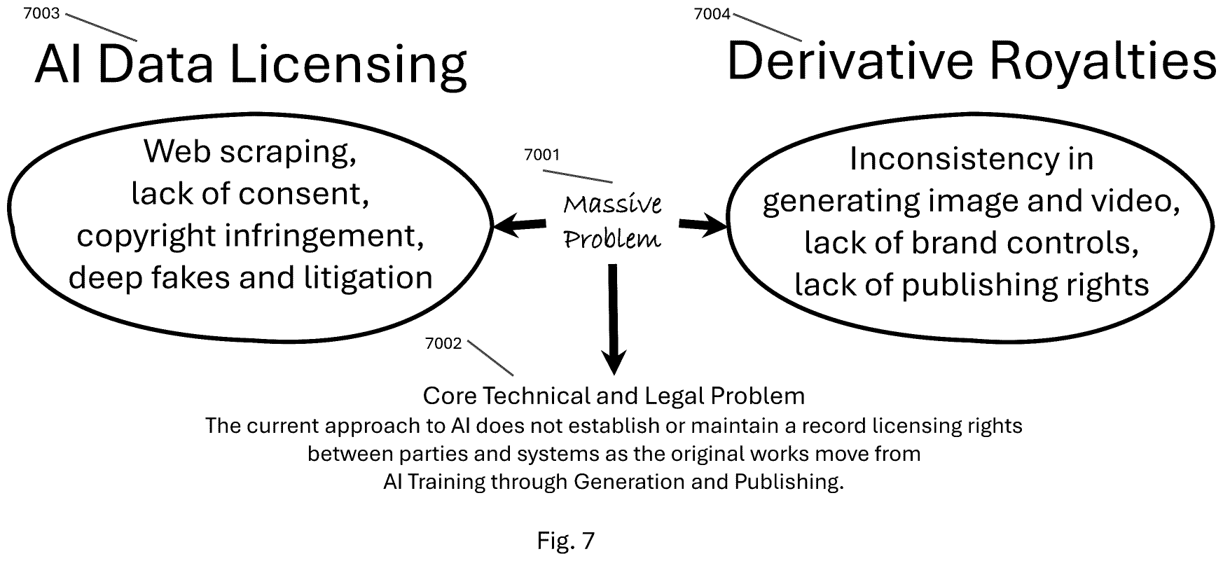

FIG. 7 illustrates example problem(s) 7001 with some existing processes related to licensing of work(s). These problem(s) often involve core technical and legal issues 7002. Aspects of the subject technology attempt to address these and other problems.

For example, existing data licensing 7003 is often based on web scraping without regard to consent of the creator(s), copyright infringement, and/or deep fakes. These issues often lead to costly litigation. Problems 7004 often involves failure for work creator(s) to be properly paid royalties on derivative works. These royalties often are not paid due to inconsistencies in generating images, videos, and/or other works, lack of brand control(s), failure to secure creator(s) publishing rights, and the like.

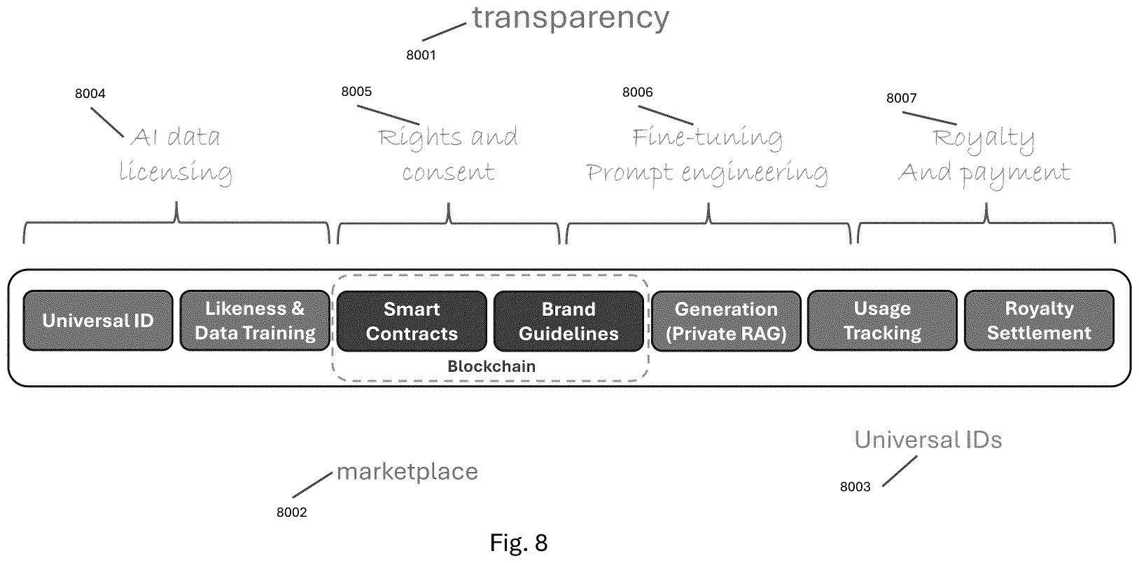

FIG. 8 illustrates end-to-end Generative AI transparency 8001 according to aspects of the subject technology. This and other aspects of the subject technology attempt to address some and/or all the problems described with respect to FIG. 7. Elements illustrated in FIG. 8 involve establishing marketplace 8002 and generation of unique/universal

IDs 8004. Elements of these processes preferably include AI data licensing 8004 involving universal and/or unique IDs and likenesses & data training; rights and/or consent 8005 by creators and/or subjects involving people and brands whose images may be protected by the subject technology along with brand guidelines (e.g., moral and copyright issues); fine tuning prompt engineering 8006 involving brand guidelines, generation of unique IDs and other information, and usage tracking; and royalty and/or payment issues 8007 involving usage tracking and/or royalty settlement.

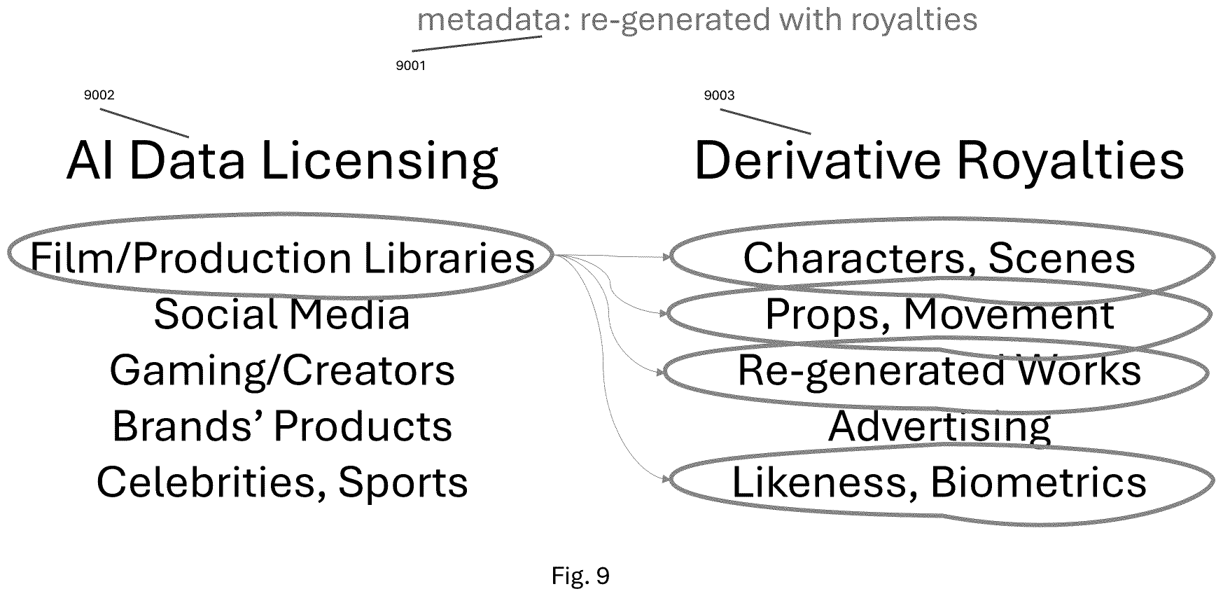

FIG. 9 illustrates regenerated data and/or metadata 9001 involving royalties according to aspects of the subject technology. For example, data licensing may relate to film/production libraries, social media, gaming/creators, brand(s) and associated product(s), one or more celebrities, sports figures, scenes, props, and/or movement(s) of camera(s).

Element 9002 represents possible embodiment(s) of AT Data Licensing. Element 9003 represents possible embodiment(s) of associated derivative royalties.

Examples regarding movement(s) of camera(s) include but are not limited to movement of motion stabilized camera(s) as developed for Star Wars, fictional character(s) (e.g., Star Wars stormtroopers, Star Trek characters, and other movie, television, and streaming media characters), actual living or deceased people, re-generated and/or derivative work(s), advertising, likeness(es) of such, and/or biometrics of fictional or actual people.

AI generated version(s) of the above also may be involved. Some or all these elements, particularly film/production libraries, may involve derivative royalties related to such regenerated data and/or metadata.

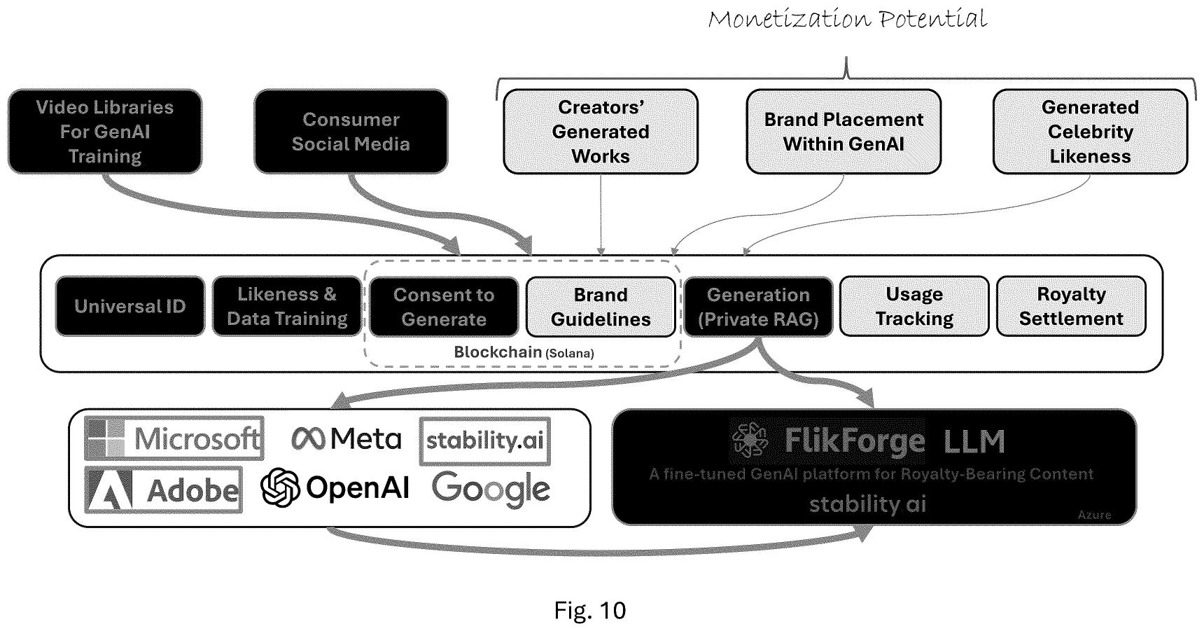

FIGS. 10 to 17 illustrate possible implementations, embodiments, and/or aspects of the subject technology, which is intended but not limited to leverage information (data), machine learning, and/or artificial intelligence for the purpose of monetization regarding likenesses of persons and/or things.

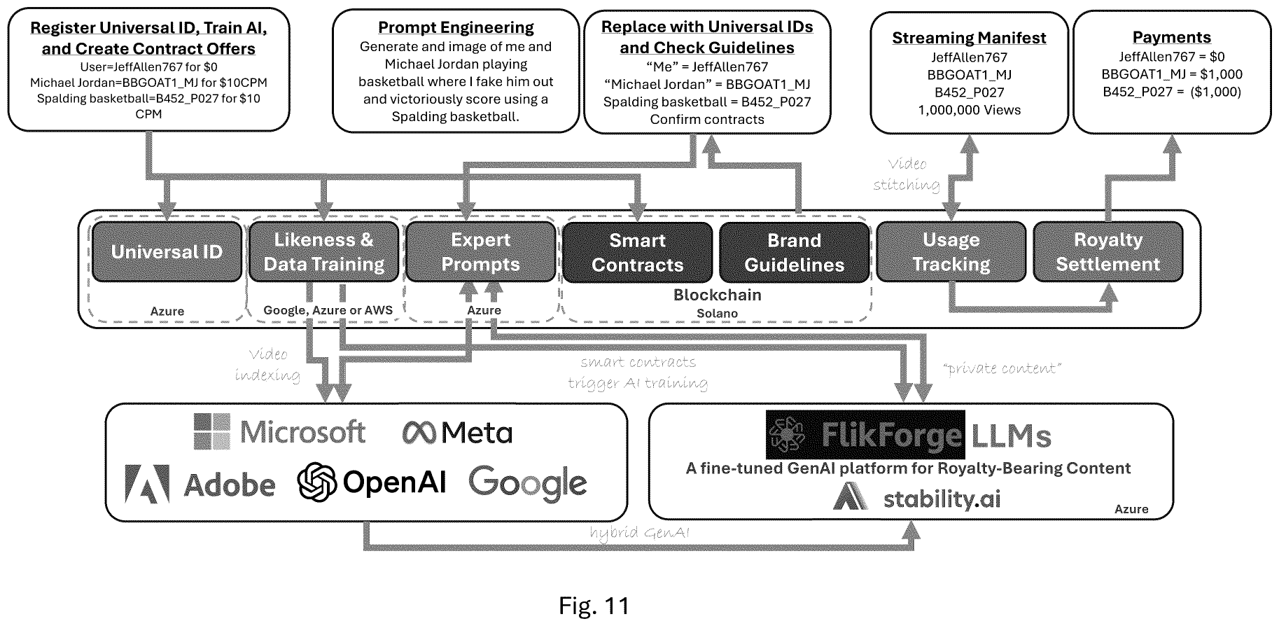

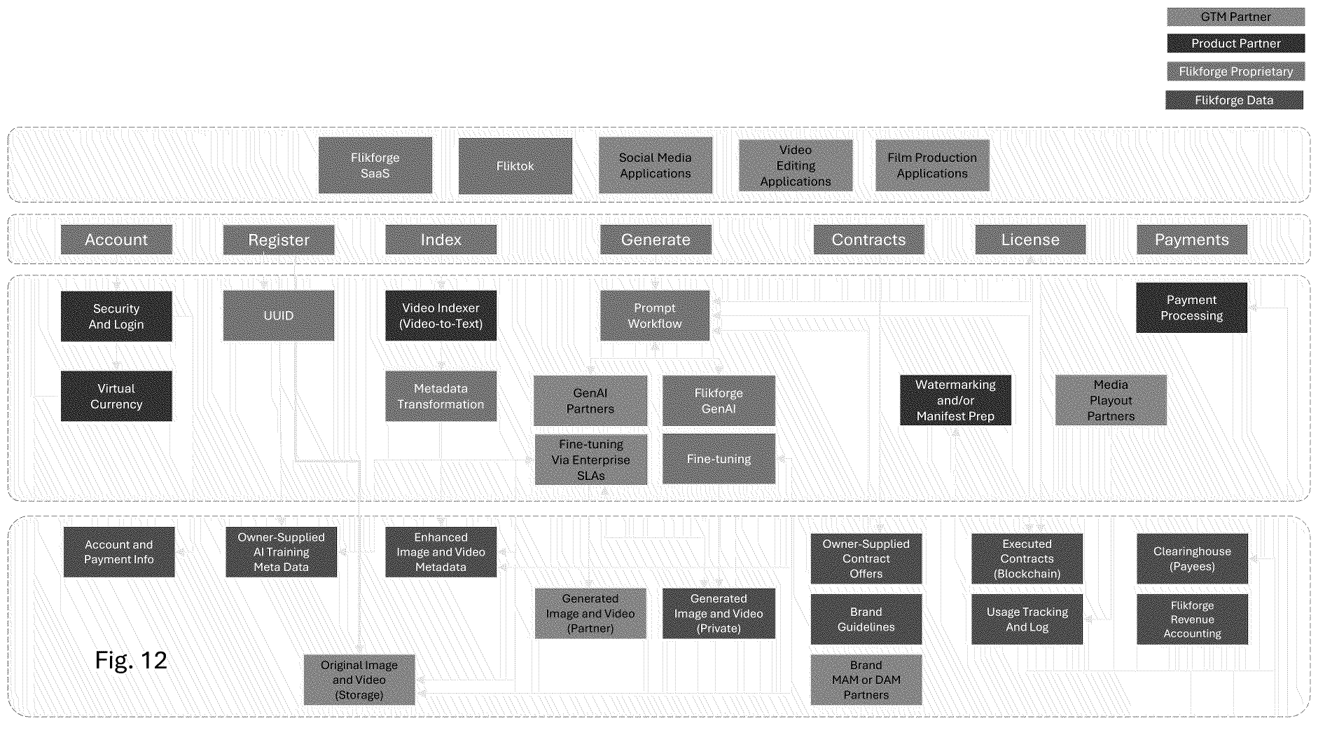

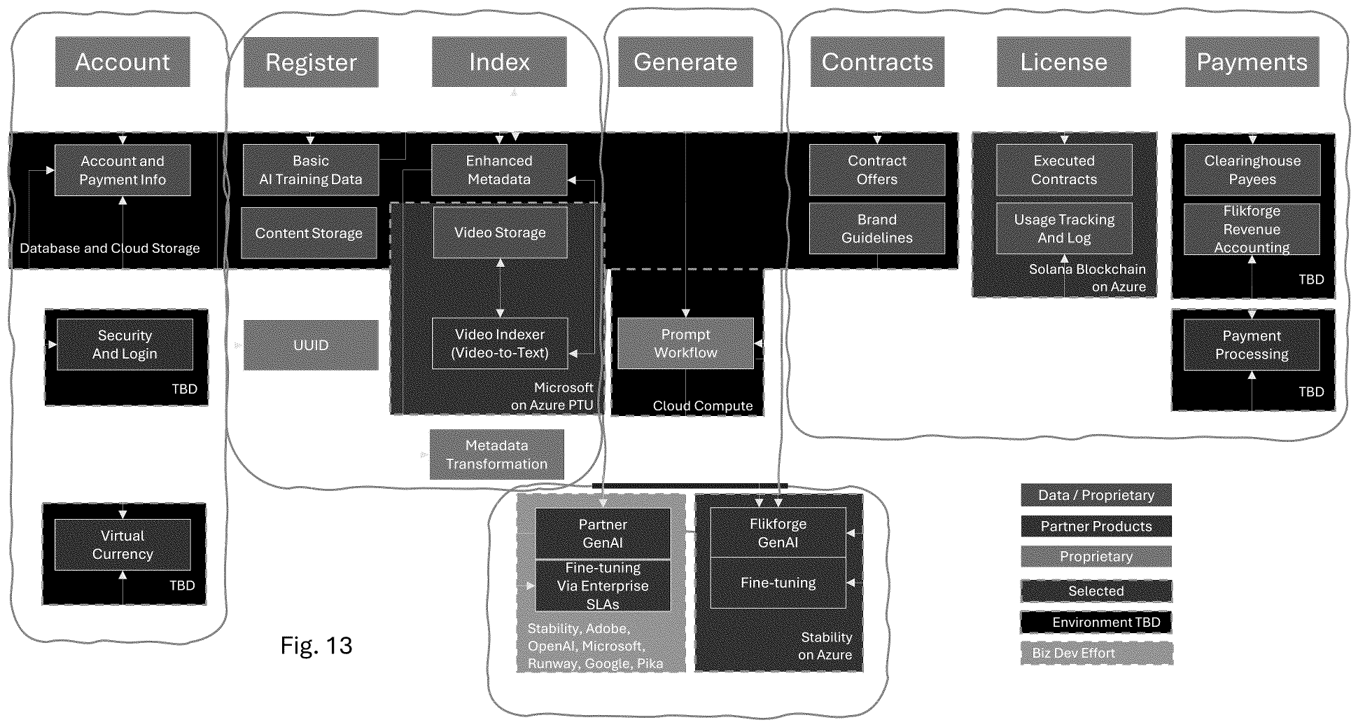

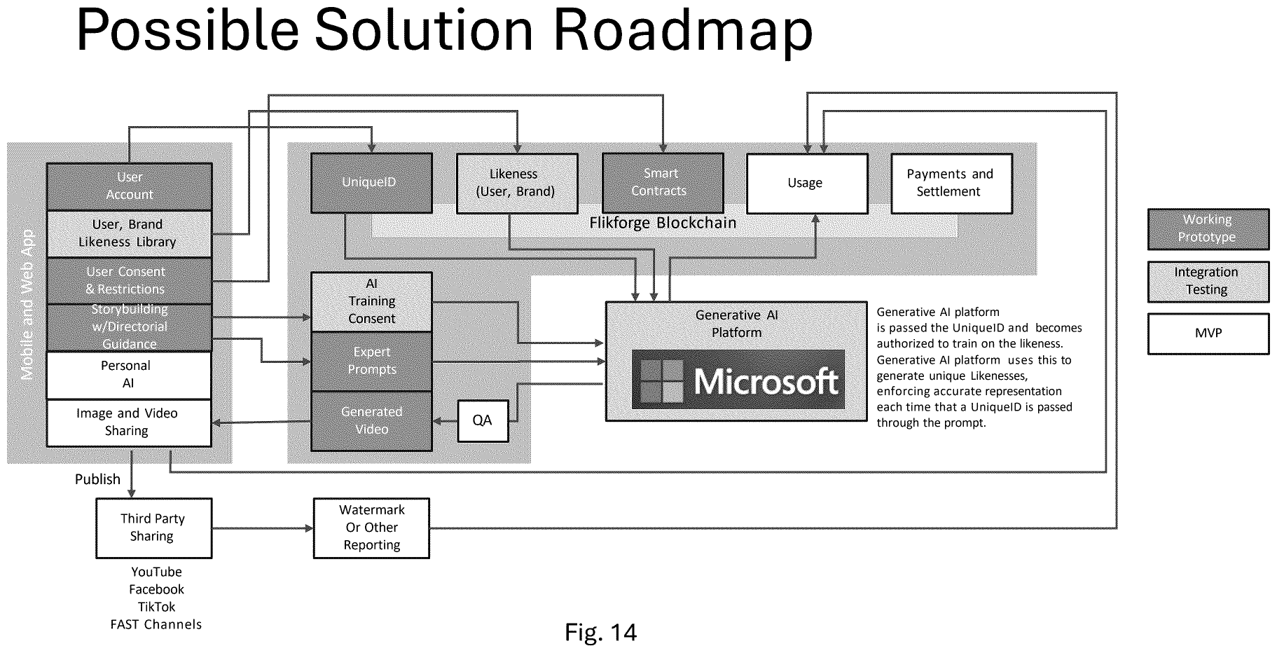

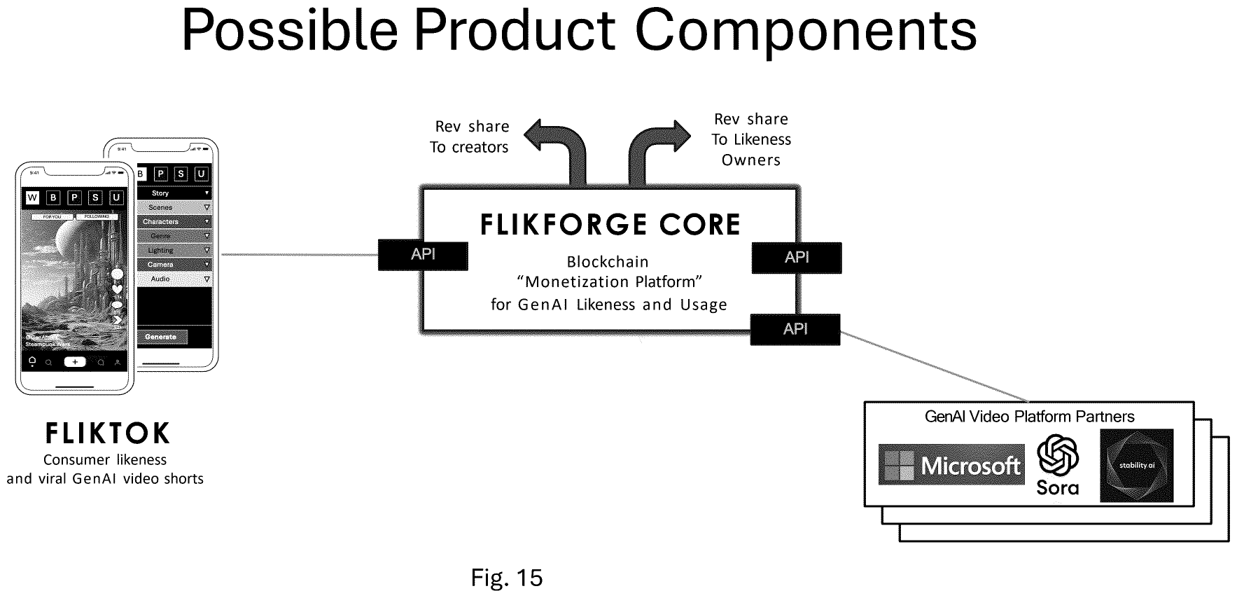

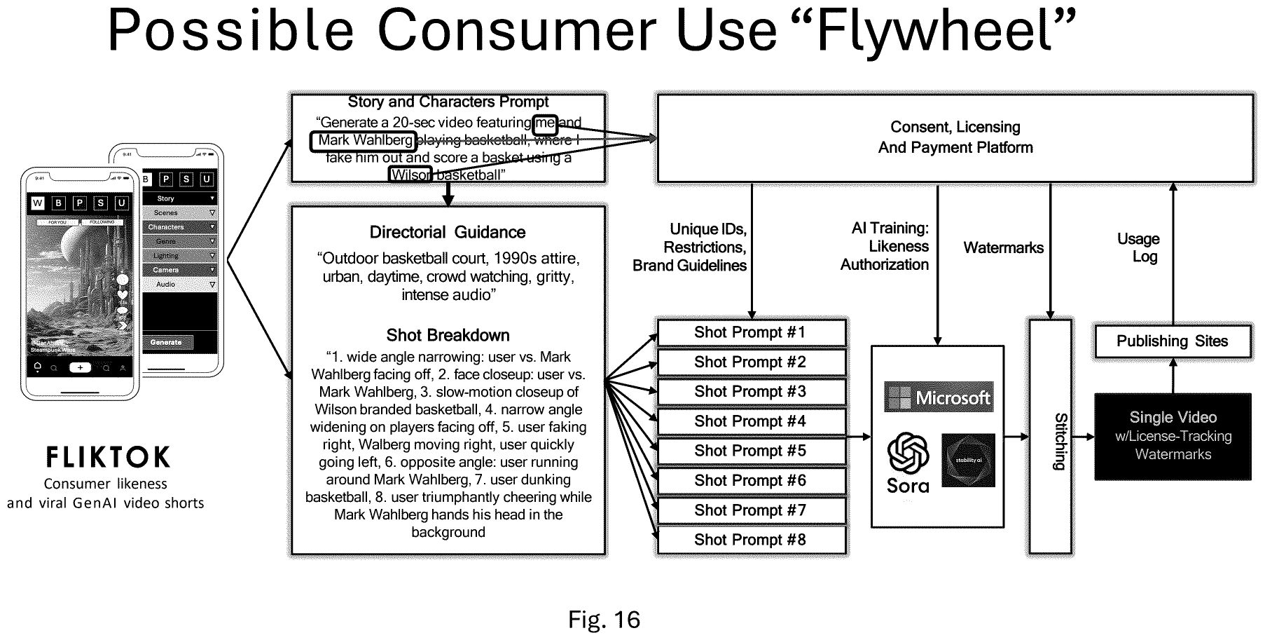

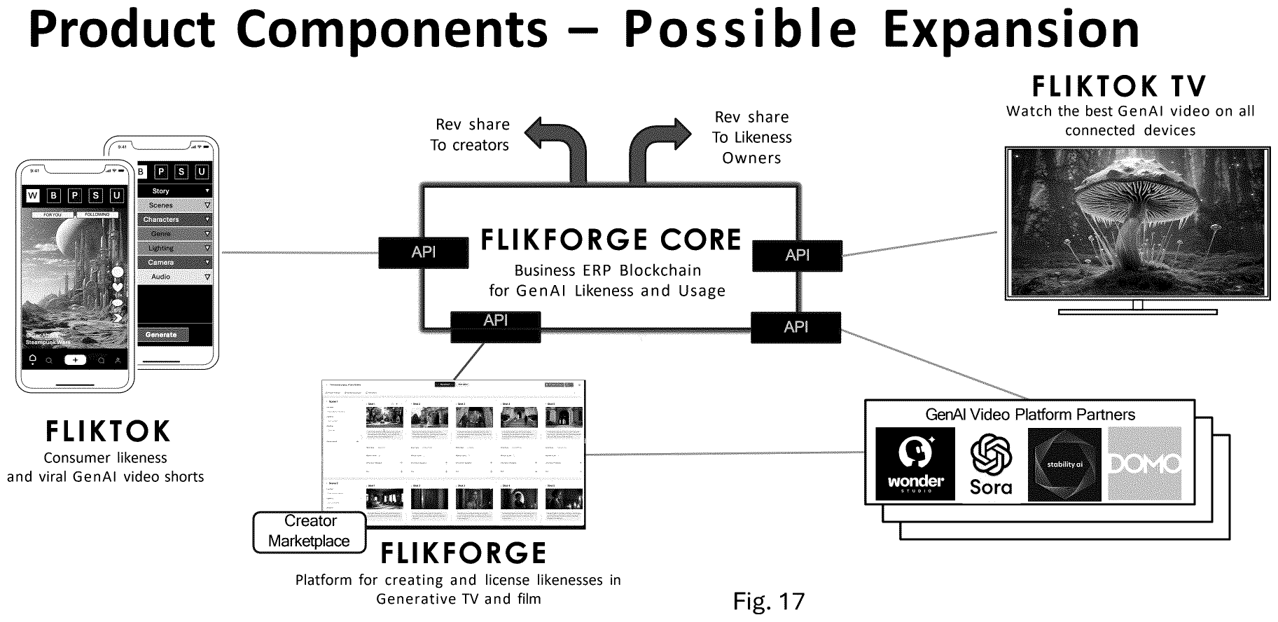

FIG. 10 illustrates monetization potential and related aspects of possible embodiments of the subject technology. FIG. 11 illustrates several relationship(s), interaction(s), communication(s), and the like that may be involved in implementing some aspects of the subject technology. FIG. 12 illustrates a Software as a Service (Saas) model that may be used to implement, leverage, and/or otherwise embody aspects of the subject technology. FIG. 13 illustrates Application Program Interfaces (APIs) and applications that may be used to implement aspects of the subject technology. FIG. 14 illustrates a possible solution roadmap according to aspects of the subject technology. FIG. 15 illustrates possible product components according to aspects of the subject technology. FIG. 16 illustrates a possible consumer use “flywheel” according to aspects of the subject technology. FIG. 17 illustrates product component(s) for possible expansion(s) according to aspects of the subject technology. These figures illustrate various component(s) and/or element(s) of possible implementation(s) described above with respect to FIGS. 1 to 9.

The subject technology is not limited to the aspects illustrated in the figures. All and/or some of the illustrated elements may be included in implementations of the technology. Other elements not illustrated in the figures may be added.

### Appendices

Appendices accompany this application and are incorporated as if fully set forth herein. The appendices should not be considered limiting.

### Generality

The invention is in no way limited to the specifics of any particular aspects disclosed herein. For example, the terms “aspect(s),” “embodiment(s),” “implementation(s),” “element(s),” “represents,” “illustrates,” “example(s),” “e. g.,” “possible,” “possibly,” “preferably,” “preferred,” “can,” “may,” “likely,” “generally,” “note,” and the like denote features that may be preferable but not necessarily essential to include in some embodiments of the invention.

Additional element(s) may be added to various aspects of the invention and/or some disclosed element(s) may be subtracted from various aspects of the invention without departing from the scope of the invention. Singular element(s) imply plural element(s) and vice versa.

Details illustrated or disclosed with respect to any one aspect of the invention may be used with other aspects of the invention. The term “and” generally includes “or” and vice versa. Many other variations/embodiments are possible which remain within the content, scope, and spirit of the invention, and these variations/embodiments would become clear to those skilled in the art after perusal of this application.

This patent claims:

1. A method that creates one or more unique identifiers for at least one digital object, comprising:
providing prompts;
receiving inputs in response to the prompts;
applying machine learning to the inputs to create the one or more unique identifiers; and
associating the one or more unique identifiers with the at least one digital object.

2. A method as in claim 1, wherein the at least one digital object comprises one or more of images, videos, audio, 3D models, skins, textures, voiceforms, metadata, and other information relating to the object.

3. A method as in claim 1, further comprising training one or more generative video systems using the one or more unique identifiers.

4. A method as in claim 1, further comprising training one or more generative image systems using the one or more unique identifiers.

5. A method as in claim 1, wherein the prompts are generated and the inputs are received by one or more portals or application program interfaces.

6. A method as in claim 1, wherein generating the prompts involves one or more blockchains.

7. A method as in claim 6, further comprising placing or storing the one or more blockchains into a central ledger.

8. A method as in claim 6, further comprising placing or storing the one or more blockchains into a distributed ledger.

9. A method as in claim 6, wherein the one or more blockchains include information related to usage of the at least one digital object.

10. A method as in claim 1, further comprising enabling retrieval of the at least one digital object based on the one or more unique identifiers associated with the at least one digital object.

11. A method as in claim 1, further comprising analyzing a user-submitted prompt to identify the presence of one or more unique identifiers embedded in the prompt.

12. A method as in claim 11, wherein unique identifiers are prefixed by a distinguishing symbol or tag to facilitate identification by the prompt processor.

13. A method as in claim 11, further comprising determining whether there exists an executed contract associated with the unique identifier and the user submitting the prompt.

14. A method as in claim 13, wherein if no executed contract exists, the method further comprises generating a contract based on the offer terms stored with the unique identifier.

15. A method as in claim 14, wherein the generated contract is executed upon user acceptance and is recorded on a blockchain as an immutable transaction.

16. A method as in claim 13, wherein if an executed contract exists, the method further comprises retrieving the specific dataset associated with the unique identifier for use in generating a likeness.

17. A method as in claim 16, further comprising retrieving brand guidelines associated with the unique identifier and applying said guidelines to modify the prompt.

18. A method as in claim 17, wherein modifying the prompt comprises removing or adding attributes to align with restrictions or enhancements defined in the brand guidelines.

19. A method as in claim 1, wherein likeness retrieval and generation are conditioned upon validation of a binding contract between user and rights holder.

20. A method as in claim 1, wherein any likeness generated by a generative AI system based on the unique identifier includes embedded metadata traceable to the contract executed.

21. A device that uses machine learning to create one or more unique identifiers for at least one digital object, the creation of the one or more unique identifiers involving steps comprising:
providing prompts;
receiving inputs in response to the prompts; applying machine learning to the inputs to create the one or more unique identifiers; and
associating the one or more unique identifiers with the at least one digital object.

22. A device as in claim 21, further comprising a processor for identifying unique identifiers in prompts and initiating contract validation based on user identity.

23. A device as in claim 21, further comprising a module for modifying prompts using brand rules linked to the unique identifier.

24. A device as in claim 21, wherein the contract execution resulting from prompt submission is recorded immutably on a blockchain.

25. A device as in claim 21, further comprising a repository interface to retrieve content assets and contractual metadata associated with each unique identifier.
